(19) United States
(12) Patent Application Publication
(10) Pub. No.: US 2017/0337402 A1
(43) Pub. Date: Nov. 23, 2017

(54) TOOL VERIFICATION SYSTEMS AND METHODS FOR A WORKFLOW PROCESS

(71) Applicant: Hand Held Products, Inc., Fort Mill, SC (US)

(72) Inventor: Erik Todeschini, Camillus, NY (US)

(21) Appl. No.: 15/157,668

(22) Filed: May 18, 2016

(51) Int. Cl. G06K 7/10

(52) U.S. Cl. CPC G06K 7/10297; G06K 7/10376

(57) ABSTRACT

A method is provided for verifying a tool for a workflow process. A processor receives workflow process comprising at least one workflow stage and identifies a task to be performed by a user, the task being at least a portion of workflow process. Processor receives decoded data from a tool, the decoded data identifying the tool. Processor verifies decoded data with verified tool in verified tool library. Processor identifies tool as a correct tool if the decoded data matches, at least in part, the verified tool and an incorrect tool if the decoded data does not match the verified tool. Processor generates and transmits an indication to the user that the tool is the correct tool or that the tool is the incorrect tool.

### FIELD OF THE INVENTION

The present invention relates to workflow systems, and more particularly, tool verification systems and methods for a workflow process such as in a warehouse environment.

### BACKGROUND

Workflow processes guide users through a particular operation, reducing the learning curve of a particular task and increasing accuracy of the operation. Workflow processes conventionally involve several workflow stages in performance of the task or in which a task is performed. For example, a workflow process may guide a user through repair and/or maintenance operations, safety checks, and a variety of other tasks that conventionally would be performed using paper checklists or from memory. The task may be at least a portion of the workflow process comprising the workflow stages.

The accurate and safe performance of workflow processes, and the prevention of equipment damage, relies on the user to ensure that a tool used to perform the task at a particular workflow stage is correct. Unfortunately, the nature of the workflow process itself and the almost infinite variety of tools may mean that the user performing the workflow process is unfamiliar with the tool to be used to perform the task and may try to use an incorrect tool.

Therefore, a need exists for tool verification systems and methods for a workflow process such as in a warehouse environment.

### SUMMARY

Accordingly, in various embodiments, the present invention embraces a method for verifying a tool for a workflow process. The method comprises a processor receiving the workflow process comprising at least one workflow stage, identifying a task that is to be performed by a user, receiving decoded data identifying a tool from the tool, verifying the decoded data with a verified tool in a verified tool library, identifying the tool as a correct tool if the decoded data matches the verified tool and an incorrect tool if the decoded data does not match the verified tool, and generating and transmitting an indication to the user that the tool is the correct tool or that the tool is the incorrect tool. The task is at least a portion of a workflow process.

A tool verification method is provided, according to various embodiments. The tool verification method comprises the processor identifying a task that is to be performed by a user, receiving decoded data identifying a tool from the tool, verifying the decoded data with a verified tool in a verified tool library, and identifying the tool as a correct tool if the decoded data matches, at least in part, the verified tool and an incorrect tool if the decoded data does not match the verified tool. The task is at least a portion of the workflow process comprising at least one workflow stage.

A tool verification system is provided, according to various embodiments. The tool verification system comprises a host computing device communicatively coupled to an identification code reader. The host computing system comprises a memory and a processor communicatively coupled to the memory. The memory stores a tool verification program and a verified tool library that specifies a verified tool to be used in a particular workflow stage of a workflow process. The identification code reader is communicatively coupled to the processor of the host computing system and comprises a sensor for reading a unique identification code and transmitting decoded data to the processor. The unique identification code is associated with a tool. The processor is configured by the tool verification program to receive the decoded data when the identification code reader is proximate the unique identification code, verify the decoded data with the verified tool library, and identify the tool as a correct tool to be used in the particular workflow stage if the decoded data matches the verified tool and an incorrect tool if the decoded data does not match the verified tool.

The foregoing illustrative summary, as well as other exemplary objectives and/or advantages of the present invention, and the manner in which the same are accomplished, are further explained within the following detailed description and its accompanying drawings.

### BRIEF DESCRIPTION OF THE DRAWINGS

FIG. 1 is a flow diagram of a tool verification method for a workflow process, according to various embodiments;

FIG. 2 is a simplified block diagram of a workflow process comprising at least one workflow stage (an exemplary three workflow stages in the depicted embodiment), according to various embodiments;

FIG. 3 is a graphical illustration of a plurality of exemplary tools configured to be used in a workflow process, each tool having a data-encoded tag according to various embodiments;

FIG. 4 is a block diagram of an exemplary tool verification system according to various embodiments that may be used to perform the tool verification method of FIG. 1, illustrating hardware and software components of a host computing device thereof, the host computing device comprising an identification code reader embedded therein according to various embodiments;

FIG. 4A is a graphical illustration of hardware and software components of the identification code reader embedded in the host computing device of FIG. 4 and a data-encoded tag (in isolation), according to various embodiments;

FIG. 5 is a block diagram of an exemplary tool verification system according to various embodiments that may be used to perform the tool verification method of FIG. 1, illustrating a host computing device communicatively coupled to a mobile device comprising an identification code reader, according to various embodiments;

FIG. 5A is a block diagram of hardware and software components of the host computing device of the tool verification system of FIG. 5, according to various embodiments;

FIG. 5B is a block diagram of hardware and software components of the identification code reader included in the mobile device of the tool verification system of FIG. 5, according to various embodiments; and

FIG. 6 is a graphical illustration of a user performing a task in a workflow stage of a workflow process such as in a warehouse environment, the user communicating via a headset to the mobile device of the tool verification system of FIG. 5 (the host computing system not shown in FIG. 6), according to various embodiments.

### DETAILED DESCRIPTION

The present invention embraces tool verification systems and methods for a workflow process such as in a warehouse environment. Various embodiments are directed to substantially ensuring that a correct tool is used for a particular task at a particular workflow stage of the workflow process. Various embodiments may be utilized to alternatively or additionally request repair and/or maintenance on a tool configured to be used in the workflow process.

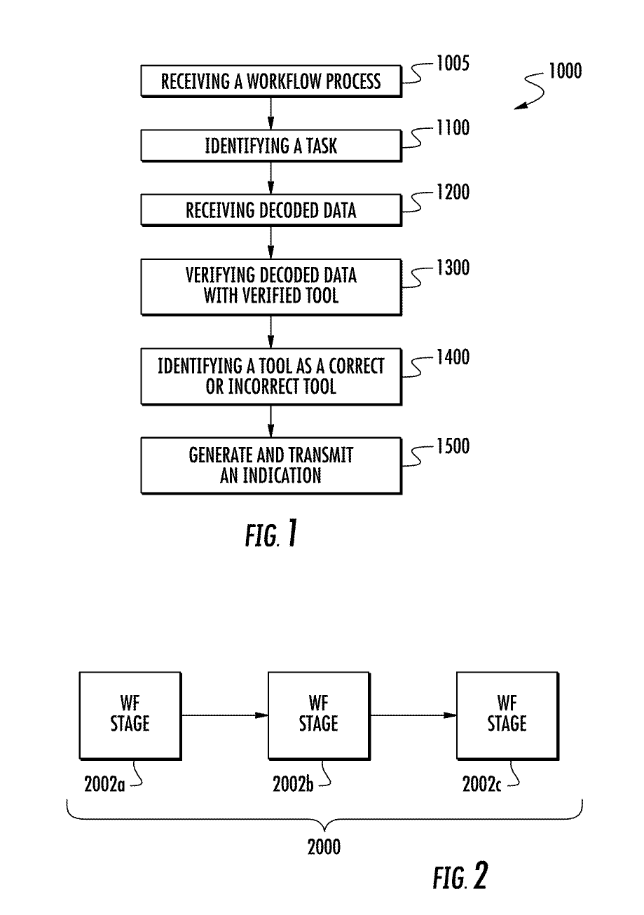

Turning now to the drawings, wherein like numbers denote like parts throughout the drawings, FIG. 1 illustrates a tool verification method 1000 (a method for verifying a tool for a workflow process) according to various embodiments. The tool verification method 1000 begins by receiving a workflow process 2000 comprising at least one workflow (WF) stage (2002a, 2002b, and 2002c in the depicted embodiment of FIG. 2) (step 1005).

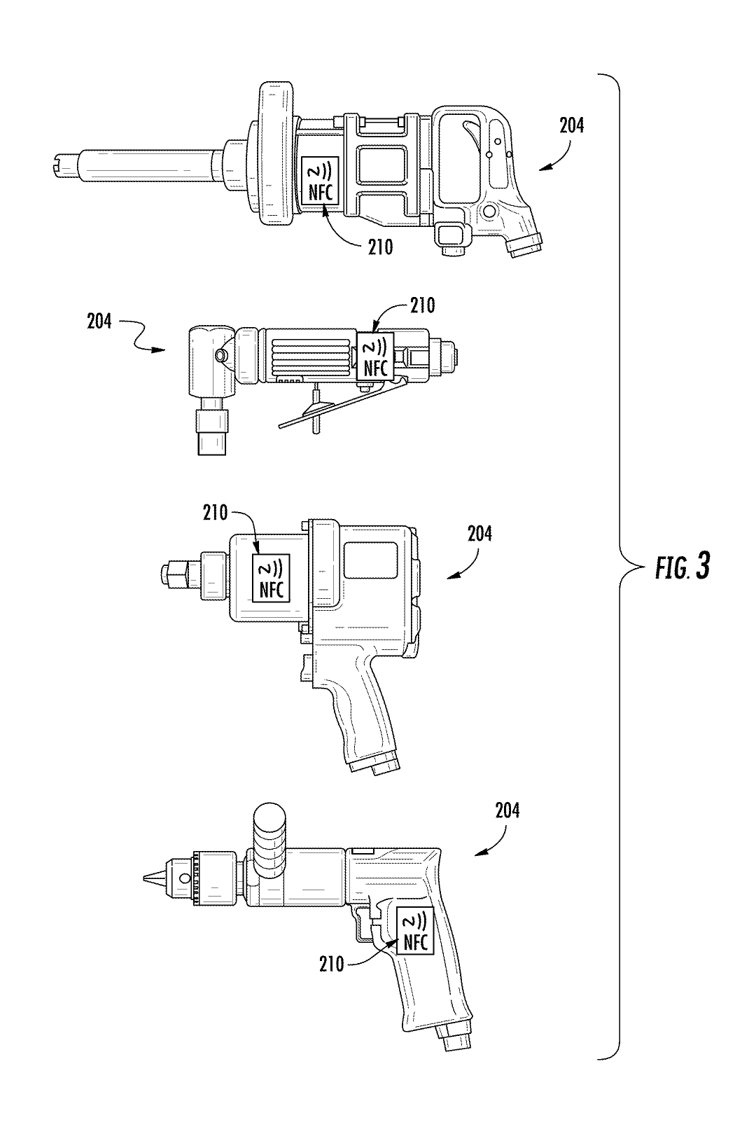

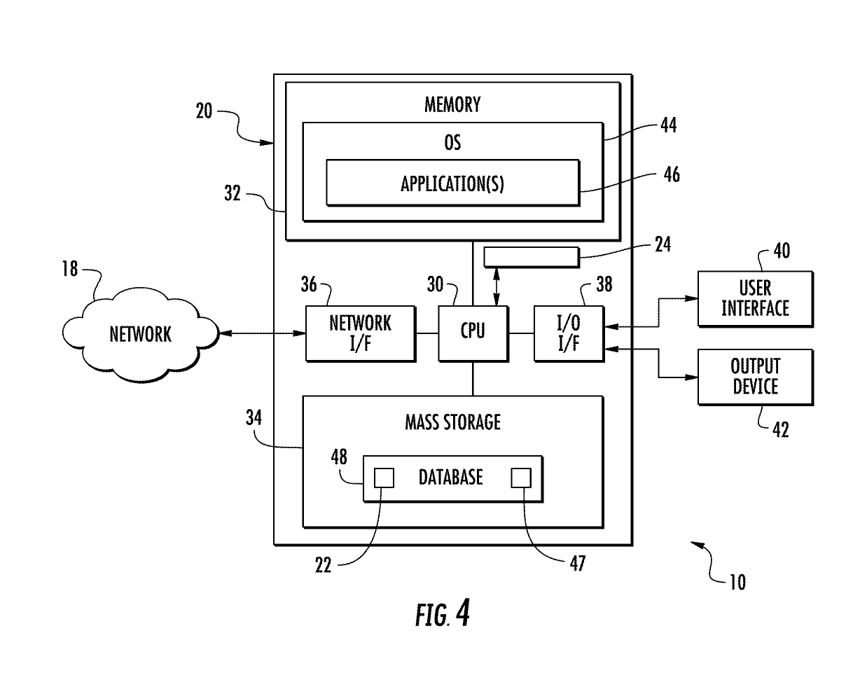

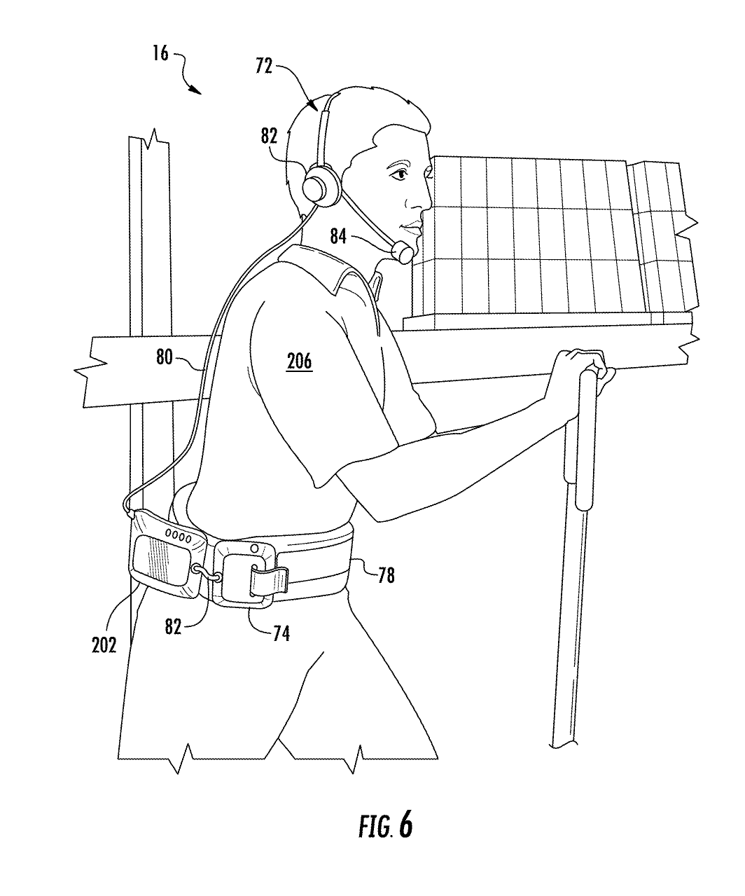

Method 1000 continues by identifying a task that is to be performed by a user (step 1100). The task comprises at least a portion of the workflow process 2000. As used herein, as noted previously, the term “workflow process” is a process that guides a user through one or more actions in performance of the particular task in a particular workflow stage. For example, a workflow process 2000 may guide a user 206 (FIG. 6) through a repair and/or maintenance operation, a safety check, and a variety of other tasks. At least one tool 204 (e.g., FIG. 3) may be used in performance of the task. A single tool or a plurality of tools may be used in a single workflow stage. A tool may not be used at all in one or more of the workflow stages 2002 of the workflow process 2000. While three exemplary workflow stages are depicted in FIG. 2, it is to be understood that there may be a fewer number or a greater number of workflow stages 2002 in the workflow process 2000.

FIG. 3 depicts a plurality of exemplary tools, each tool 204 configured to be used in at least one workflow stage of the workflow process. As used herein, the term “tool” may include a tool, an instrument, a piece of equipment, or the like. While the exemplary tools depicted in FIG. 3 are power tools, it is to be understood that other than power tools may be verified by the tool verification systems and methods according to various embodiments.

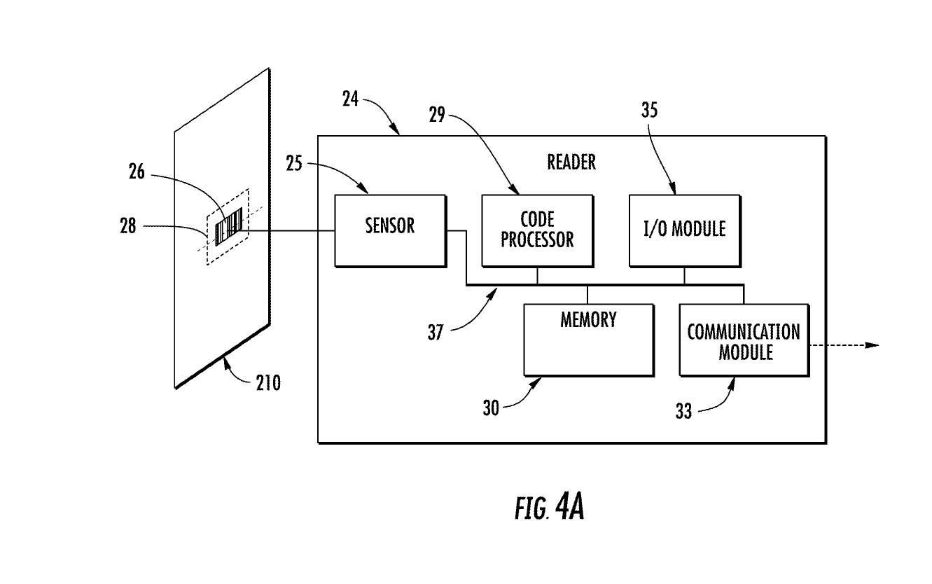

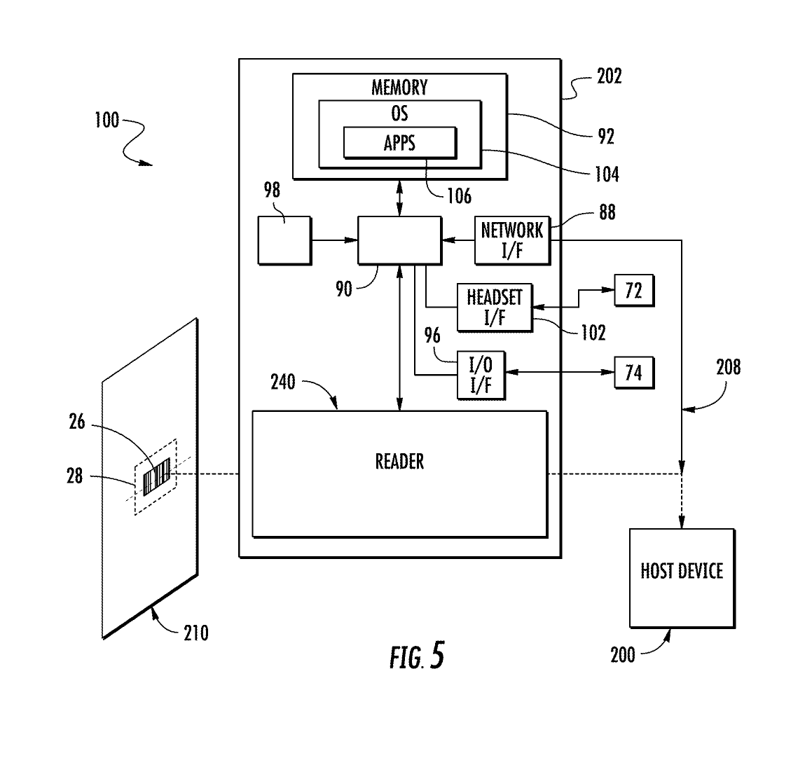

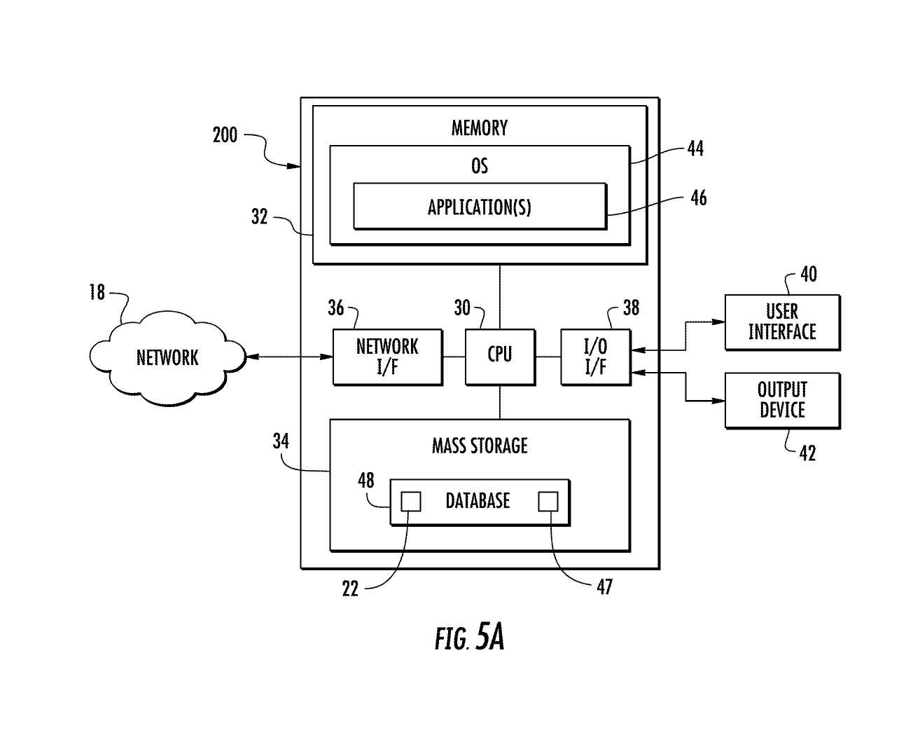

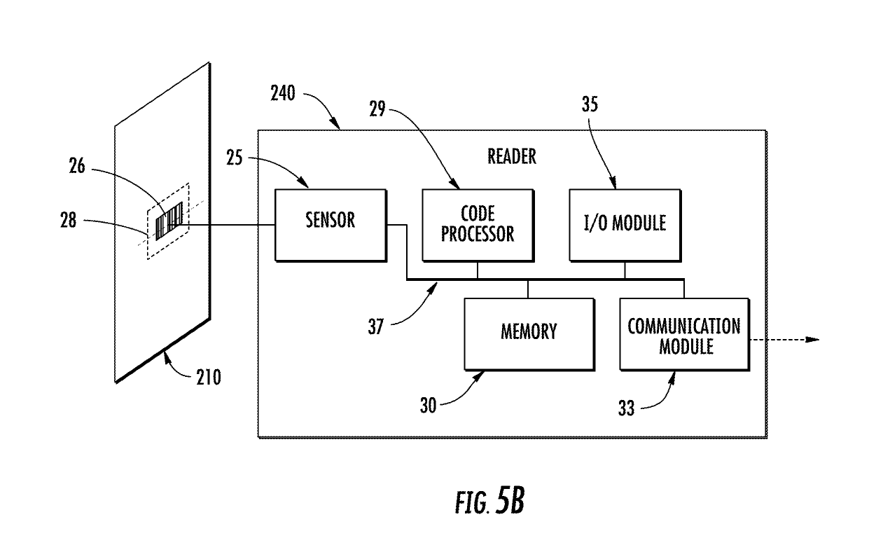

As depicted in FIG. 3, each tool 204 of the plurality of depicted tools has a tag 28 with a unique identification code 26 (herein a “data-encoded tag” 210). The data-encoded tag 210 may be in the form of a small sticker, an engraving, a label, or the like associated with the tool 204 by affixation or the like. An exemplary data-encoded tag 210 is shown in isolation (i.e., not associated with a tool) in FIGS. 4A, 5, and 5B. The unique identification code 26 represents tool identification information. The tool identification information may include information about the tool itself, a particular workflow stage, and/or a task for which the tool 204 is to be used. Therefore, the unique identification code 26 is associated with a tool 204 configured to be used for a particular task in at least one particular workflow stage 2002 of the workflow process 2000. The data-encoded tag 210 may be a nearfield communication code (NFC) tag, a radio frequency (RFID) tag, a Bluetooth® tag, a barcode, an optical tag, or the like. The data-encoded tag 210 may be a passive data-encoded tag that does not have a power source and only transmits decoded data upon receiving a signal emitted from an identification code reader 24/240 (e.g., identification code reader 24 is depicted in FIG. 4A and identification code reader 240 is depicted in FIG. 5B) in proximity thereof as hereinafter described. As used herein, the term “proximity” may require actual contact of the data-encoded tag (more particularly, the unique identification code) with the identification code reader 24/240 so that the data-encoded tag 210 can receive the signal emitted from the identification code reader or actual contact may not be required depending upon, for example, the sensitivity or range of the identification code reader 24/240. While a passive data-encoded tag is described, it is to be understood that an active data-encoded tag as known to one skilled in the art may be used, according to various embodiments. The decoded data may be, for example, digital data representing the tool identification information stored in the unique identification code. The decoded data identifies the tool to be verified according to the tool verification systems and methods described herein according to various embodiments.

Referring now to FIGS. 4 and 4A, according to various embodiments, the tool verification system 10 to be used in the tool verification method 1000 of FIG. 1 is depicted. In various embodiments, the tool verification system 10 comprises a host computing device 20 coupled to a network 18. The host computing device 20 includes at least one central processing unit (CPU) (or simply a “processor”) 30 communicatively coupled to a memory 32. Each CPU 30 is typically implemented in hardware using circuit logic disposed on one or more physical integrated circuit devices or chips and may be one or more microprocessors, micro-controllers, FPGAs, or ASICs. Memory 32 may include RAM, DRAM, SRAM, flash memory, and/or another digital storage medium, and also typically implemented using circuit logic disposed on one or more physical integrated circuit devices, or chips. As such, memory 32 may be considered to include memory storage physically located elsewhere in the host computing device 20, e.g., any cache memory in the at least one CPU 30, as well as any storage capacity used as a virtual memory, e.g., as stored on a mass storage device 34, another computing system (not shown), a network storage device (e.g., a tape drive) (not shown), or another network device (not shown) coupled to the host computing device 20 through at least one network interface 36 (illustrated and referred to hereinafter as “network I/F” 36) by way of the network 18. In various embodiments, as depicted in FIG. 4, the identification code reader 24 as hereinafter described may be embedded in the host computing system 20.

In various embodiments, the host computing device 20 is a computing system, such as a computer, computing device, server, disk array, or programmable device, including a handheld computing device, a laptop computing device, a tablet computing device, a networked device (including a computer in a cluster configuration), a mobile telecommunications device, a video game console (or other gaming system), or other computing system that may operate as a multi-user computer or a single-user computer.

The host computing device 20 is typically under the control of an operating system 44 and executes or otherwise relies upon various computer software applications, sequences of operations, components, programs, files, objects, modules, etc., according to various embodiments of the present invention. In various embodiments, the host computing device 20 executes or otherwise relies on one or more applications 46 that are configured to provide task messages or task instructions to the user. The task messages or task instructions may be communicated to the user to execute a task in the workflow process 2000 that involves performance of the task using a tool 204. The one or more applications 46 may also be configured to store a tool verification program 22 and/or a verified tool library 47 in a database 48 within the mass storage 34. The verified tool library 47 specifies a verified tool to be used for each specific task in the at least one workflow stage 2002 (e.g., 2002a, 2002b, 2002c of FIG. 2) of the workflow process 2000.

The processor 30 of host computing device 20 is configured to receive the workflow process comprising the at least one workflow stage and identify the task that is to be performed by the user. As noted previously, the task is at least a portion of the workflow process. As hereinafter described, the processor 30 of host computing device 20 is also configured to receive decoded data from the tool (step 1200 of method 1000 as hereinafter described) when the identification code reader 24 is proximate the unique identification code 26, verify the decoded data with a verified tool in the verified tool library 47 (step 1300 of method 1000) and identify the tool 204 as a correct tool to be used in the particular workflow stage 2002 if the decoded data matches the verified tool and an incorrect tool if the decoded data does not match the verified tool (step 1400 of method 1000). The processor of host computing device 20 is also configured to generate and transmit an indication to the user that the tool is the correct tool or that the tool is the incorrect tool (step 1500 of method 1000). The indication may be, for example, an alert if the tool is identified as the incorrect tool. The processor may be further configured to stop the workflow process if the tool is identified as the incorrect tool and/or generate and transmit a description to the user of the correct tool if the tool is identified as the incorrect tool. The processor 30 of host computing device may further be configured to generate a work order on the tool if work is requested on the tool, wherein generating the work order comprises printing the work order.

In various embodiments, the host computing device 20 further comprises the identification code reader 24 (i.e., as noted previously, the identification code reader 24 may be embedded in the host computing device 20 as depicted in FIG. 4). Referring now specifically to FIG. 4A, according to various embodiments, the identification code reader 24 is configured to read the unique identification code 26 on the data-encoded tag 210 associated with the tool 204. The identification code reader 24 comprises a sensor 25 for reading the unique identification code 26, a memory 30, and a code processor 29 for converting the unique identification code 26 into the decoded data and transmitting the decoded data to the processor 30 of the host computing device 20. The identification code reader 24 may include a communication module 33 and an input/output module 35. The identification code reader 24 may use a variety of techniques to read the unique identification code 26 included in/on the data-encoded tag 210.

The subsystems in the identification code reader 24 are electrically connected via couplers (e.g., wires or fibers) to form an interconnection subsystem 37. The interconnection system 37 may include power buses or lines, data buses, instruction buses, address buses, etc., which allow operation of the modules/subsystems and the interaction there between.

Returning to FIG. 4, according to various embodiments, the host computing device 20 may be coupled to at least one peripheral device through an input/output device interface 38 (illustrated as, and hereinafter, “I/O I/F” 38). In particular, the host computing device 20 may receive data from a user (e.g., 206 of FIG. 6) through at least one user interface 40 (including, for example, a keyboard, mouse, a microphone, and/or other user interface) and/or outputs data to the user through at least one output device 42 (including, for example, a display, speakers, a printer, and/or another output device). Moreover, in various embodiments, the I/O I/F 38 communicates with a device that is operative as a user interface 40 and output device 42 in combination, such as a touch screen display (not shown).

In various embodiments depicted in FIG. 4, the output device 42 of tool verification system 10 and/or the input/output (I/O) module 35 (e.g., user interface) of identification code reader 24 (FIG. 4A) may display an incorrect tool alert or transmit an indication that the tool is correct or incorrect as hereinafter described (e.g., visual and/or auditory alerts). The output device 42 and/or the input/output module 35 may additionally or alternatively describe to the user the correct tool to be used if the tool 204 is identified as the incorrect tool (i.e., not the correct tool for a particular task and/or not the correct tool to be used in a particular workflow stage, etc.).

Referring now to FIGS. 5, 5A, and 5B, in various embodiments, a tool verification system 100 comprises a host computing device 200 communicatively coupled to a mobile device 202 including an identification code reader 240 (the mobile device 202 is also communicatively coupled to the host computing device 200). Host computing device 200 (FIG. 5A) of tool verification system 100 differs from host computing device 20 of tool verification system 10 (FIG. 4) in that host computing device 200 does not include embedded identification code reader 24. Unless otherwise indicated, the hardware and software components of host computing device 20 and 200 are otherwise the same and will not be herein described again for host computing device 200. FIG. 5B depicts the identification code reader 240 included in mobile device 202 (see, e.g., FIG. 5). Unless otherwise indicated, the hardware and software components of identification code reader 240 are the same as described for identification code reader 24 and therefore will not be described again here. Like processor 30 of host computing device 20, the processor 30 of host computing device 200 is configured by the tool verification program 22 to receive the workflow process comprising at least one workflow stage (step 1005) and identify a task that is to be performed by a user (step 1100). The processor 30 of host computing device 200 is configured to receive decoded data from the tool (step 1200 as hereinafter described) when the identification code reader 240 is proximate the unique identification code 26, verify the decoded data with the verified tool in the verified tool library 47 (step 1300 as hereinafter described) and identify the tool 204 as a correct tool to be used in the particular workflow stage 2002 if the decoded data matches the verified tool and an incorrect tool if the decoded data does not match the verified tool (step 1400 as hereinafter described). The processor 30 of host computing device 200 is configured to generate and transmit an indication (such as an alert) to the user that the tool is the correct tool or that the tool is the incorrect tool (step 1500 as hereinafter described). The processor 30 of host computing device 200 may be further configured to stop the workflow process if the tool is identified the incorrect tool and/or generate and transmit a description to the user of the correct tool if the tool is identified as the incorrect tool. The processor 30 of host computing device 200 may be further configured to generate a work order on the tool if work is requested on the tool, wherein generating the work order comprises printing the work order.

Still referring to FIG. 5, according to various embodiments, the mobile device 202 may be communicatively coupled to the host computing device (more particularly, the processor 30 of the host computing device) as a peripheral device through the input/output device interface 38 of host computing device 200 with at least one wireless data link 208 (e.g., IEEE 802.11, including WI-FI®, BLUETOOTH®, ZIGBEE®, CDMA, TDMA, or GSM wireless communication protocols). The host computing device 200 and the mobile device 202 are configured to communicate via the wireless data link 208 through the at least one network 18, which may include at least one private communications network (e.g., such as an intranet) and/or at least one public communications network (e.g., such as the Internet) and/or a personal area network (PAN).

FIG. 5 includes a block diagram of the hardware and software components of the mobile device 202 according to various embodiments of the present invention. The mobile device 202 includes a wireless or wired network interface (network I/F 88), at least one processing unit 90 coupled to a memory 92, and an identification code reader 240. As in CPU 30 (“processor” 30) of host computing device 20, each processing unit 90 is typically implemented in hardware using circuit logic disposed in one or more physical integrated circuit devices, or chips. Each processing unit 90 may be one or more microprocessors, micro-controllers, field programmable gate arrays, or ASICs, while memory 92 may include RAM, DRAM, SRAM, flash memory, and/or another digital storage medium, and that is also typically implemented using circuit logic disposed in one or more physical integrated circuit devices, or chips. As such, memory 92 is considered to include memory storage physically located elsewhere in the mobile device 202, e.g., any cache memory in the at least one processing unit 90, as well as any storage capacity used as a virtual memory, e.g., as stored on a mass storage device, a computer, and/or or another device coupled to the mobile device 202, including coupled to the mobile device 202 through the at least one network I/F 88 by way of the network 18. The mobile device 202, in turn, couples to the network 18 through the network I/F 88 with at least one wired and/or wireless connection.

The mobile device 202 also includes a power supply 98, such as a battery, rechargeable battery, rectifier, and/or other power source. The mobile device 202 may be configured to communicate with a headset 72 (see, e.g., FIG. 6) through a headset interface 102 (illustrated as, and hereinafter, “headset I/F” 102), which is in turn configured to couple to the headset 72 through a cord 80 and/or wirelessly. In various embodiments, the mobile device 202 may couple to the headset 72 through a wireless technology, such as the BlueTooth® open wireless technology standard that is known in the art. The mobile device 202 and headset 72 may therefore communicate wirelessly. The mobile device 202 and headset 72 may be incorporated with each other in a single, self-contained unit. As such, the single, self-contained mobile system may be worn by the user 206.

The headset 72 may include one or more speakers 82 and one or more microphones 84. The speaker 82 is configured to play audio (e.g., such as speech output associated with a voice dialog to instruct the user 206 to perform the task), while the microphone 84 is configured to capture speech input from the user 206 (e.g., such as a request for repair or maintenance of the tool). As such, and in various embodiments, the user 206 may interface with the mobile device 202 hands-free through the headset 72.

The mobile device 202 may be under the control and/or otherwise rely upon various software applications, components, programs, files, objects, modules, etc. (hereinafter, “program code”) according to various embodiments of the present invention. This program code may include an operating system 104 (e.g., such as a Windows Embedded Compact operating system as distributed by Microsoft Corporation of Redmond, Wash.) as well as one or more software applications (e.g., configured to operate in an operating system or as “stand-alone” applications). As such, the memory 92 may also be configured with one or more task applications 106. The one or more task applications 106, similarly to those of the host computing system, process messages or task instructions for the user 206 (e.g., by displaying and/or converting the task messages or task instructions into speech output). In various embodiments, as illustrated in FIG. 6, the mobile device 202 may comprise a portable and/or wearable mobile device worn by the user 206, such as on a belt 78. In various embodiments, the mobile device 202 may be carried or otherwise transported, such as on the user's forearm, or on a lift truck, harness, or other manner of transportation. In various embodiments, the mobile device 202 may be positioned on a table or the like near a workspace in the workflow stage 2002.

While the identification code reader embedded in the host computing device 20 of tool verification system 10 may read and transmit decoded data to the processor 30 from the data-encoded tag 210 associated with the tool, it may be easier for the user to use the tool verification system 100 comprising the host computing device 200 communicatively coupled to the mobile device 202 comprising the identification code reader 240. For example, if the host computing device comprises a server and the mobile device comprises a belt-worn mobile device, it may be easier to touch the tool 204 (more particularly, the unique identification code on the data-encoded tag associated with the tool) to the belt (more particularly, to the mobile device including the identification code reader) rather than to the identification code reader 24 on the server 200.

Still referring to FIGS. 5 and 6, according to various embodiments, the mobile device 202 may include at least one input/output interface 96 (illustrated as, and hereinafter, “I/O I/F” 96) configured to communicate with at least one peripheral other than the headset 72. Such a peripheral may include, for example, a printer 74 such as shown in the depicted embodiment (FIGS. 5 and 6), an image scanner, a monitor, a user interface (e.g., keyboard, keypad), an output device, a touch screen, to name a few. In various embodiments, the I/O I/F 96 includes at least one peripheral interface, including at least one of one or more serial, universal serial bus (USB), PC Card, VGA, HDMI, DVI, and/or other interfaces (e.g., for example, other computer, communicative, data, audio, and/or visual interfaces) (none shown). Moreover, the mobile device 202 is configured to communicate with the printer 74 through a printer cord 82 and/or wirelessly. In various embodiments, the mobile device 202 couples to the printer 74 through the BlueTooth® open wireless technology standard or other wireless communication protocols that are known in the art. In FIG. 6, the mobile device 202 and the printer 74 are shown attached to a belt. The mobile device 202 and the printer 74 may individually or together be communicatively coupled to the host computing device 200 (the host computing device 200 is not shown in FIG. 6). In various embodiments, the printer 74 may be used to print a repair/maintenance work order that may be generated and transmitted by the processor 30 of the host computing system 20/200. While the I/O I/F 96 is shown as a separate interface from headset I/F 102 in FIG. 5, it is to be understood that the interfaces may be combined into a single interface.

Referring again to FIG. 1, the tool verification method 1000 continues by receiving the decoded data when the identification code reader is proximate the unique identification code (step 1200). The user 206 may manipulate the tool 204 and/or the identification code reader 24/240 such that the identification code reader 24/240 is in proximity to the unique identification code 26. The identification code reader 24/240 reads the unique identification code associated with the tool 204 and transmits the decoded data to the processor of the host computing device 20/200.

The tool verification program configures the processor (30 of FIGS. 4 and 5A) of the host computing system 20/200 to receive the unique identification code from the sensor 25 of the identification code reader 24/240 as a scanned signal (e.g., modulated analog signal or image). It then converts this scanned signal into decoded data (e.g., digital data representing the tool identification information stored in the unique identification code).

Still referring to FIG. 1, according to various embodiments, the tool verification method 1000 continues by verifying the decoded data with the verified tool library (step 1300). The processor 30 of the host computing system 20/200 verifies the decoded data with verified tools in the verified tool library. A “verified tool” is predetermined to be the correct tool for performing a particular task in a particular workflow stage of the workflow process. Data representing the verified tool is stored in the verified tool library 47.

Still referring to FIG. 1, according to various embodiments, the tool verification method 1000 continues by identifying the tool as a correct tool or an incorrect tool (step 1400). If the decoded data matches the verified tool in the verified tool library (or meets some other criteria based on stored data in the verified tool library) (verified for performing the particular task in the particular workflow stage), then the decoded data is identified as being from a correct tool. If the decoded data does not match the verified tool, the decoded data is identified as being from an incorrect tool.

If the tool is identified as the correct tool to be used for performing the particular task in the particular workflow stage of the workflow process, the user may proceed with use of the tool. The user may receive an indication from the processor 30 that he/she is manipulating the correct tool, i.e., the processor may generate and transmit an indication to the user that the tool is the correct tool or that the tool is the incorrect tool (step 1500 of method 1000). The indication may be an audible indication or the like, such as an alert that the tool is the incorrect tool to be used for the task in the particular workflow stage.

If the tool is identified by the processor as the incorrect tool, the processor may stop the workflow process until a different tool is identified as the correct tool for the particular workflow stage. If the tool is identified as the incorrect tool, the host computing device and/or the mobile device may generate and transmit an alert (an exemplary indication) to the user that he/she does not have the correct tool for the particular task and/or for the particular workflow stage. The host computing device (more particularly, the processor thereof) and/or the mobile device may alternatively or additionally generate and transmit a description to the user of the correct tool (e.g., verbally, through the user interface, etc.).

In various embodiments, the user may request maintenance and/or repair (herein “work”) on the tool using hardware and software components of tool verification system 10 and/or tool verification system 100. For example, the user 206 may verbally request work on the tool 204 using the headset 72 and manipulate the tool (more particularly, the unique identification code associated therewith) and/or the identification code reader in proximity to each other. The processor 30 of the host computing device 20/200 and/or the processing unit 90 of the mobile device 202 may then generate a work order for the tool. The request for work on the tool may be performed at any time prior to, during, or after tool verification. The request for work on the tool may occur without tool verification.

A person having ordinary skill in the art will recognize that the environments illustrated in FIGS. 4-6 are not intended to limit the scope of embodiments of the present invention. In particular, the host computing device 20 and 200 and/or the mobile device 202 and/or the identification code reader 24/240 may include fewer or additional components, or alternative configurations, consistent with various embodiments of the present invention.

Thus, a person having skill in the art will recognize that other alternative hardware and/or software environments may be used without departing from the scope of the present invention. For example, a person having ordinary skill in the art will appreciate that the host computing device and/or mobile device may include more or fewer applications disposed therein. As such, other alternative hardware and software environments may be used without departing from the scope of various embodiments of the present invention. Moreover, a person having ordinary skill in the art will appreciate that the terminology used to describe various pieces of data, task messages, task instructions, voice dialogs, speech output, speech input, and machine readable input are merely used for purposes of differentiation and are not intended to be limiting.

The routines executed to implement various embodiments of the present invention, whether implemented as part of an operating system or a specific application, component, program, object, module or sequence of instructions executed by one or more computing systems will be referred to herein as a “sequence of operations,” a “program product,” or, more simply, “program code.” The program code typically comprises one or more instructions that are resident at various times in various memory and storage devices in a computing system (e.g., the host computing device and/or mobile device), and that, when read and executed by one or more processors of the components of the host computing device and/or the mobile device, cause that computing system to perform the steps necessary to execute steps, elements, and/or blocks embodying the various aspects of the present invention.

While the present invention has and hereinafter will be described in the context of fully functioning computing systems, those skilled in the art will appreciate that the various embodiments of the present invention are capable of being distributed as a program product in a variety of forms, and that the particular invention applies equally regardless of the particular type of computer readable media used to actually carry out the distribution. Examples of computer readable media include but are not limited to physical and tangible recordable type media such as volatile and nonvolatile memory devices, floppy and other removable disks, hard disk drives, optical disks (e.g., CD-ROM's, DVD's, Blu-Ray disks, etc.), among others.

In addition, various program code described hereinafter may be identified based upon the application or software component within which it is implemented in various embodiment of the present invention. However, it should be appreciated that any particular program nomenclature that follows is used merely for convenience, and thus the present invention should not be limited to use solely in any specific application identified and/or implied by such nomenclature. Furthermore, given the typically endless number of manners in which computer programs may be organized into routines, procedures, methods, modules, objects, and the like, as well as the various manners in which program functionality may be allocated among various software layers that are resident within a typical computer (e.g., operating systems, libraries, APIs, applications, applets, etc.), it should be appreciated that the present invention is not limited to the specific organization and allocation of program functionality described herein.

To supplement the present disclosure, this application incorporates entirely by reference the following commonly assigned patents, patent application publications, and patent applications:
U.S. Pat. No. 6,832,725; U.S. Pat. No. 7,128,266;
U.S. Pat. No. 7,159,783; U.S. Pat. No. 7,413,127;
U.S. Pat. No. 7,726,575; U.S. Pat. No. 8,294,969;
U.S. Pat. No. 8,317,105; U.S. Pat. No. 8,322,622;
U.S. Pat. No. 8,366,005; U.S. Pat. No. 8,371,507;
U.S. Pat. No. 8,376,233; U.S. Pat. No. 8,381,979;
U.S. Pat. No. 8,390,909; U.S. Pat. No. 8,408,464;
U.S. Pat. No. 8,408,468; U.S. Pat. No. 8,408,469;
U.S. Pat. No. 8,424,768; U.S. Pat. No. 8,448,863;
U.S. Pat. No. 8,457,013; U.S. Pat. No. 8,459,557;
U.S. Pat. No. 8,469,272; U.S. Pat. No. 8,474,712;
U.S. Pat. No. 8,479,992; U.S. Pat. No. 8,490,877;
U.S. Pat. No. 8,517,271; U.S. Pat. No. 8,523,076;
U.S. Pat. No. 8,528,818; U.S. Pat. No. 8,544,737;
U.S. Pat. No. 8,548,242; U.S. Pat. No. 8,548,420;
U.S. Pat. No. 8,550,335; U.S. Pat. No. 8,550,354;
U.S. Pat. No. 8,550,357; U.S. Pat. No. 8,556,174;
U.S. Pat. No. 8,556,176; U.S. Pat. No. 8,556,177;
U.S. Pat. No. 8,559,767; U.S. Pat. No. 8,599,957;
U.S. Pat. No. 8,561,895; U.S. Pat. No. 8,561,903;
U.S. Pat. No. 8,561,905; U.S. Pat. No. 8,565,107;
U.S. Pat. No. 8,571,307; U.S. Pat. No. 8,579,200;
U.S. Pat. No. 8,583,924; U.S. Pat. No. 8,584,945;
U.S. Pat. No. 8,587,595; U.S. Pat. No. 8,587,697;
U.S. Pat. No. 8,588,869; U.S. Pat. No. 8,590,789;
U.S. Pat. No. 8,596,539; U.S. Pat. No. 8,596,542;
U.S. Pat. No. 8,596,543; U.S. Pat. No. 8,599,271;
U.S. Pat. No. 8,599,957; U.S. Pat. No. 8,600,158;
U.S. Pat. No. 8,600,167; U.S. Pat. No. 8,602,309;
U.S. Pat. No. 8,608,053; U.S. Pat. No. 8,608,071;
U.S. Pat. No. 8,611,309; U.S. Pat. No. 8,615,487;
U.S. Pat. No. 8,616,454; U.S. Pat. No. 8,621,123;
U.S. Pat. No. 8,622,303; U.S. Pat. No. 8,628,013;
U.S. Pat. No. 8,628,015; U.S. Pat. No. 8,628,016;
U.S. Pat. No. 8,629,926; U.S. Pat. No. 8,630,491;
U.S. Pat. No. 8,635,309; U.S. Pat. No. 8,636,200;
U.S. Pat. No. 8,636,212; U.S. Pat. No. 8,636,215;
U.S. Pat. No. 8,636,224; U.S. Pat. No. 8,638,806;
U.S. Pat. No. 8,640,958; U.S. Pat. No. 8,640,960;
U.S. Pat. No. 8,643,717; U.S. Pat. No. 8,646,692;
U.S. Pat. No. 8,646,694; U.S. Pat. No. 8,657,200;
U.S. Pat. No. 8,659,397; U.S. Pat. No. 8,668,149;
U.S. Pat. No. 8,678,285; U.S. Pat. No. 8,678,286;
U.S. Pat. No. 8,682,077; U.S. Pat. No. 8,687,282;
U.S. Pat. No. 8,692,927; U.S. Pat. No. 8,695,880;
U.S. Pat. No. 8,698,949; U.S. Pat. No. 8,717,494;
U.S. Pat. No. 8,717,494; U.S. Pat. No. 8,720,783;
U.S. Pat. No. 8,723,804; U.S. Pat. No. 8,723,904;
U.S. Pat. No. 8,727,223; U.S. Pat. No. D702,237;
U.S. Pat. No. 8,740,082; U.S. Pat. No. 8,740,085;
U.S. Pat. No. 8,746,563; U.S. Pat. No. 8,750,445;
U.S. Pat. No. 8,752,766; U.S. Pat. No. 8,756,059;
U.S. Pat. No. 8,757,495; U.S. Pat. No. 8,760,563;
U.S. Pat. No. 8,763,909; U.S. Pat. No. 8,777,108;
U.S. Pat. No. 8,777,109; U.S. Pat. No. 8,779,898;
U.S. Pat. No. 8,781,520; U.S. Pat. No. 8,783,573;
U.S. Pat. No. 8,789,757; U.S. Pat. No. 8,789,758;
U.S. Pat. No. 8,789,759; U.S. Pat. No. 8,794,520;
U.S. Pat. No. 8,794,522; U.S. Pat. No. 8,794,525;
U.S. Pat. No. 8,794,526; U.S. Pat. No. 8,798,367;
U.S. Pat. No. 8,807,431; U.S. Pat. No. 8,807,432;
U.S. Pat. No. 8,820,630; U.S. Pat. No. 8,822,848;
U.S. Pat. No. 8,824,692; U.S. Pat. No. 8,824,696;
U.S. Pat. No. 8,842,849; U.S. Pat. No. 8,844,822;
U.S. Pat. No. 8,844,823; U.S. Pat. No. 8,849,019;
U.S. Pat. No. 8,851,383; U.S. Pat. No. 8,854,633;
U.S. Pat. No. 8,866,963; U.S. Pat. No. 8,868,421;
U.S. Pat. No. 8,868,519; U.S. Pat. No. 8,868,802;
U.S. Pat. No. 8,868,803; U.S. Pat. No. 8,870,074;
U.S. Pat. No. 8,879,639; U.S. Pat. No. 8,880,426;
U.S. Pat. No. 8,881,983; U.S. Pat. No. 8,881,987;
U.S. Pat. No. 8,903,172; U.S. Pat. No. 8,908,995;
U.S. Pat. No. 8,910,870; U.S. Pat. No. 8,910,875;
U.S. Pat. No. 8,914,290; U.S. Pat. No. 8,914,788;
U.S. Pat. No. 8,915,439; U.S. Pat. No. 8,915,444;
U.S. Pat. No. 8,916,789; U.S. Pat. No. 8,918,250;
U.S. Pat. No. 8,918,564; U.S. Pat. No. 8,925,818;
U.S. Pat. No. 8,939,374; U.S. Pat. No. 8,942,480;
U.S. Pat. No. 8,944,313; U.S. Pat. No. 8,944,327;
U.S. Pat. No. 8,944,332; U.S. Pat. No. 8,950,678;
U.S. Pat. No. 8,967,468; U.S. Pat. No. 8,971,346;
U.S. Pat. No. 8,976,030; U.S. Pat. No. 8,976,368;
U.S. Pat. No. 8,978,981; U.S. Pat. No. 8,978,983;
U.S. Pat. No. 8,978,984; U.S. Pat. No. 8,985,456;
U.S. Pat. No. 8,985,457; U.S. Pat. No. 8,985,459;
U.S. Pat. No. 8,985,461; U.S. Pat. No. 8,988,578;
U.S. Pat. No. 8,988,590; U.S. Pat. No. 8,991,704;
U.S. Pat. No. 8,996,194; U.S. Pat. No. 8,996,384;
U.S. Pat. No. 9,002,641; U.S. Pat. No. 9,007,368;
U.S. Pat. No. 9,010,641; U.S. Pat. No. 9,015,513;
U.S. Pat. No. 9,016,576; U.S. Pat. No. 9,022,288;
U.S. Pat. No. 9,030,964; U.S. Pat. No. 9,033,240;
U.S. Pat. No. 9,033,242; U.S. Pat. No. 9,036,054;
U.S. Pat. No. 9,037,344; U.S. Pat. No. 9,038,911;
U.S. Pat. No. 9,038,915; U.S. Pat. No. 9,047,098;
U.S. Pat. No. 9,047,359; U.S. Pat. No. 9,047,420;
U.S. Pat. No. 9,047,525; U.S. Pat. No. 9,047,531;
U.S. Pat. No. 9,053,055; U.S. Pat. No. 9,053,378;
U.S. Pat. No. 9,053,380; U.S. Pat. No. 9,058,526;
U.S. Pat. No. 9,064,165; U.S. Pat. No. 9,064,167;
U.S. Pat. No. 9,064,168; U.S. Pat. No. 9,064,254;
U.S. Pat. No. 9,066,032; U.S. Pat. No. 9,070,032;
U.S. Design Pat. No. D716,285;
U.S. Design Pat. No. D723,560;
U.S. Design Pat. No. D730,357;
U.S. Design Pat. No. D730,901;
U.S. Design Pat. No. D730,902;
U.S. Design Pat. No. D733,112;
U.S. Design Pat. No. D734,339;
International Publication No. 2013/163789;
International Publication No. 2013/173985;
International Publication No. 2014/019130;
International Publication No. 2014/110495;
U.S. Patent Application Publication No. 2008/0185432;
U.S. Patent Application Publication No. 2009/0134221;
U.S. Patent Application Publication No. 2010/0177080;
U.S. Patent Application Publication No. 2010/0177076;
U.S. Patent Application Publication No. 2010/0177707;
U.S. Patent Application Publication No. 2010/0177749;
U.S. Patent Application Publication No. 2010/0265880;
U.S. Patent Application Publication No. 2011/0202554;
U.S. Patent Application Publication No. 2012/0111946;
U.S. Patent Application Publication No. 2012/0168511;
U.S. Patent Application Publication No. 2012/0168512;
U.S. Patent Application Publication No. 2012/0193423;
U.S. Patent Application Publication No. 2012/0203647;
U.S. Patent Application Publication No. 2012/0223141;
U.S. Patent Application Publication No. 2012/0228382;
U.S. Patent Application Publication No. 2012/0248188;
U.S. Patent Application Publication No. 2013/0043312;
U.S. Patent Application Publication No. 2013/0082104;
U.S. Patent Application Publication No. 2013/0175341;
U.S. Patent Application Publication No. 2013/0175343;
U.S. Patent Application Publication No. 2013/0257744;
U.S. Patent Application Publication No. 2013/0257759;
U.S. Patent Application Publication No. 2013/0270346;
U.S. Patent Application Publication No. 2013/0287258;
U.S. Patent Application Publication No. 2013/0292475;
U.S. Patent Application Publication No. 2013/0292477;
U.S. Patent Application Publication No. 2013/0293539;
U.S. Patent Application Publication No. 2013/0293540;
U.S. Patent Application Publication No. 2013/0306728;
U.S. Patent Application Publication No. 2013/0306731;
U.S. Patent Application Publication No. 2013/0307964;
U.S. Patent Application Publication No. 2013/0308625;
U.S. Patent Application Publication No. 2013/0313324;
U.S. Patent Application Publication No. 2013/0313325;
U.S. Patent Application Publication No. 2013/0342717;
U.S. Patent Application Publication No. 2014/0001267;
U.S. Patent Application Publication No. 2014/0008439;
U.S. Patent Application Publication No. 2014/0025584;
U.S. Patent Application Publication No. 2014/0034734;
U.S. Patent Application Publication No. 2014/0036848;
U.S. Patent Application Publication No. 2014/0039693;
U.S. Patent Application Publication No. 2014/0042814;
U.S. Patent Application Publication No. 2014/0049120;
U.S. Patent Application Publication No. 2014/0049635;
U.S. Patent Application Publication No. 2014/0061306;
U.S. Patent Application Publication No. 2014/0063289;
U.S. Patent Application Publication No. 2014/0066136;
U.S. Patent Application Publication No. 2014/0067692;
U.S. Patent Application Publication No. 2014/0070005;
U.S. Patent Application Publication No. 2014/0071840;
U.S. Patent Application Publication No. 2014/0074746;
U.S. Patent Application Publication No. 2014/0076974;
U.S. Patent Application Publication No. 2014/0078341;
U.S. Patent Application Publication No. 2014/0078345;
U.S. Patent Application Publication No. 2014/0097249;
U.S. Patent Application Publication No. 2014/0098792;
U.S. Patent Application Publication No. 2014/0100813;
U.S. Patent Application Publication No. 2014/0103115;
U.S. Patent Application Publication No. 2014/0104413;
U.S. Patent Application Publication No. 2014/0104414;
U.S. Patent Application Publication No. 2014/0104416;
U.S. Patent Application Publication No. 2014/0104451;
U.S. Patent Application Publication No. 2014/0106594;
U.S. Patent Application Publication No. 2014/0106725;
U.S. Patent Application Publication No. 2014/0108010;
U.S. Patent Application Publication No. 2014/0108402;
U.S. Patent Application Publication No. 2014/0110485;
U.S. Patent Application Publication No. 2014/0114530;
U.S. Patent Application Publication No. 2014/0124577;
U.S. Patent Application Publication No. 2014/0124579;
U.S. Patent Application Publication No. 2014/0125842;
U.S. Patent Application Publication No. 2014/0125853;
U.S. Patent Application Publication No. 2014/0125999;
U.S. Patent Application Publication No. 2014/0129378;
U.S. Patent Application Publication No. 2014/0131438;
U.S. Patent Application Publication No. 2014/0131441;
U.S. Patent Application Publication No. 2014/0131443;
U.S. Patent Application Publication No. 2014/0131444;
U.S. Patent Application Publication No. 2014/0131445;
U.S. Patent Application Publication No. 2014/0131448;
U.S. Patent Application Publication No. 2014/0133379;
U.S. Patent Application Publication No. 2014/0136208;
U.S. Patent Application Publication No. 2014/0140585;
U.S. Patent Application Publication No. 2014/0151453;
U.S. Patent Application Publication No. 2014/0152882;
U.S. Patent Application Publication No. 2014/0158770;
U.S. Patent Application Publication No. 2014/0159869;
U.S. Patent Application Publication No. 2014/0166755;
U.S. Patent Application Publication No. 2014/0166759;
U.S. Patent Application Publication No. 2014/0168787;
U.S. Patent Application Publication No. 2014/0175165;
U.S. Patent Application Publication No. 2014/0175172;
U.S. Patent Application Publication No. 2014/0191644;
U.S. Patent Application Publication No. 2014/0191913;
U.S. Patent Application Publication No. 2014/0197238;
U.S. Patent Application Publication No. 2014/0197239;
U.S. Patent Application Publication No. 2014/0197304;
U.S. Patent Application Publication No. 2014/0214631;
U.S. Patent Application Publication No. 2014/0217166;
U.S. Patent Application Publication No. 2014/0217180;
U.S. Patent Application Publication No. 2014/0231500;
U.S. Patent Application Publication No. 2014/0232930;
U.S. Patent Application Publication No. 2014/0247315;
U.S. Patent Application Publication No. 2014/0263493;
U.S. Patent Application Publication No. 2014/0263645;
U.S. Patent Application Publication No. 2014/0267609;
U.S. Patent Application Publication No. 2014/0270196;
U.S. Patent Application Publication No. 2014/0270229;
U.S. Patent Application Publication No. 2014/0278387;
U.S. Patent Application Publication No. 2014/0278391;
U.S. Patent Application Publication No. 2014/0282210;
U.S. Patent Application Publication No. 2014/0284384;
U.S. Patent Application Publication No. 2014/0288933;
U.S. Patent Application Publication No. 2014/0297058;
U.S. Patent Application Publication No. 2014/0299665;
U.S. Patent Application Publication No. 2014/0312121;
U.S. Patent Application Publication No. 2014/0319220;
U.S. Patent Application Publication No. 2014/0319221;
U.S. Patent Application Publication No. 2014/0326787;
U.S. Patent Application Publication No. 2014/0332590;
U.S. Patent Application Publication No. 2014/0344943;
U.S. Patent Application Publication No. 2014/0346233;
U.S. Patent Application Publication No. 2014/0351317;
U.S. Patent Application Publication No. 2014/0353373;
U.S. Patent Application Publication No. 2014/0361073;
U.S. Patent Application Publication No. 2014/0361082;
U.S. Patent Application Publication No. 2014/0362184;
U.S. Patent Application Publication No. 2014/0363015;
U.S. Patent Application Publication No. 2014/0369511;
U.S. Patent Application Publication No. 2014/0374483;
U.S. Patent Application Publication No. 2014/0374485;
U.S. Patent Application Publication No. 2015/0001301;
U.S. Patent Application Publication No. 2015/0001304;
U.S. Patent Application Publication No. 2015/0003673;
U.S. Patent Application Publication No. 2015/0009338;
U.S. Patent Application Publication No. 2015/0009610;
U.S. Patent Application Publication No. 2015/0014416;
U.S. Patent Application Publication No. 2015/0021397;
U.S. Patent Application Publication No. 2015/0028102;
U.S. Patent Application Publication No. 2015/0028103;
U.S. Patent Application Publication No. 2015/0028104;
U.S. Patent Application Publication No. 2015/0029002;
U.S. Patent Application Publication No. 2015/0032709;
U.S. Patent Application Publication No. 2015/0039309;
U.S. Patent Application Publication No. 2015/0039878;
U.S. Patent Application Publication No. 2015/0040378;
U.S. Patent Application Publication No. 2015/0048168;
U.S. Patent Application Publication No. 2015/0049347;
U.S. Patent Application Publication No. 2015/0051992;
U.S. Patent Application Publication No. 2015/0053766;
U.S. Patent Application Publication No. 2015/0053768;
U.S. Patent Application Publication No. 2015/0053769;
U.S. Patent Application Publication No. 2015/0060544;
U.S. Patent Application Publication No. 2015/0062366;
U.S. Patent Application Publication No. 2015/0063215;
U.S. Patent Application Publication No. 2015/0063676;
U.S. Patent Application Publication No. 2015/0069130;
U.S. Patent Application Publication No. 2015/0071819;
U.S. Patent Application Publication No. 2015/0083800;
U.S. Patent Application Publication No. 2015/0086114;
U.S. Patent Application Publication No. 2015/0088522;
U.S. Patent Application Publication No. 2015/0096872;
U.S. Patent Application Publication No. 2015/0099557;
U.S. Patent Application Publication No. 2015/0100196;
U.S. Patent Application Publication No. 2015/0102109;
U.S. Patent Application Publication No. 2015/0115035;
U.S. Patent Application Publication No. 2015/0127791;
U.S. Patent Application Publication No. 2015/0128116;
U.S. Patent Application Publication No. 2015/0129659;
U.S. Patent Application Publication No. 2015/0133047;
U.S. Patent Application Publication No. 2015/0134470;
U.S. Patent Application Publication No. 2015/0136851;
U.S. Patent Application Publication No. 2015/0136854;
U.S. Patent Application Publication No. 2015/0142492;
U.S. Patent Application Publication No. 2015/0144692;
U.S. Patent Application Publication No. 2015/0144698;
U.S. Patent Application Publication No. 2015/0144701;
U.S. Patent Application Publication No. 2015/0149946;
U.S. Patent Application Publication No. 2015/0161429;
U.S. Patent Application Publication No. 2015/0169925;
U.S. Patent Application Publication No. 2015/0169929;
U.S. Patent Application Publication No. 2015/0178523;
U.S. Patent Application Publication No. 2015/0178534;
U.S. Patent Application Publication No. 2015/0178535;
U.S. Patent Application Publication No. 2015/0178536;
U.S. Patent Application Publication No. 2015/0178537;
U.S. Patent Application Publication No. 2015/0181093;
U.S. Patent Application Publication No. 2015/0181109;
U.S. patent application Ser. No. 13/367,978 for a Laser Scanning Module Employing an Elastomeric U-Hinge Based Laser Scanning Assembly, filed Feb. 7, 2012 (Feng et al.);
U.S. patent application Ser. No. 29/458,405 for an Electronic Device, filed Jun. 19, 2013 (Fitch et al.);
U.S. patent application Ser. No. 29/459,620 for an Electronic Device Enclosure, filed Jul. 2, 2013 (London et al.);
U.S. patent application Ser. No. 29/468,118 for an Electronic Device Case, filed Sep. 26, 2013 (Oberpriller et al.);
U.S. patent application Ser. No. 14/150,393 for Indicia-reader Having Unitary Construction Scanner, filed Jan. 8, 2014 (Colavito et al.);
U.S. patent application Ser. No. 14/200,405 for Indicia Reader for Size-Limited Applications filed Mar. 7, 2014 (Feng et al.);
U.S. patent application Ser. No. 14/231,898 for Hand-Mounted Indicia-Reading Device with Finger Motion Triggering filed Apr. 1, 2014 (Van Horn et al.);
U.S. patent application Ser. No. 29/486,759 for an Imaging Terminal, filed Apr. 2, 2014 (Oberpriller et al.);
U.S. patent application Ser. No. 14/257,364 for Docking System and Method Using Near Field Communication filed Apr. 21, 2014 (Showering);
U.S. patent application Ser. No. 14/264,173 for Autofocus Lens System for Indicia Readers filed Apr. 29, 2014 (Ackley et al.);
U.S. patent application Ser. No. 14/277,337 for MULTIPURPOSE OPTICAL READER, filed May 14, 2014 (Jovanovski et al.);
U.S. patent application Ser. No. 14/283,282 for TERMINAL HAVING ILLUMINATION AND FOCUS CONTROL filed May 21, 2014 (Liu et al.);
U.S. patent application Ser. No. 14/327,827 for a MOBILE-PHONE ADAPTER FOR ELECTRONIC TRANSACTIONS, filed Jul. 10, 2014 (Hejl);
U.S. patent application Ser. No. 14/334,934 for a SYSTEM AND METHOD FOR INDICIA VERIFICATION, filed Jul. 18, 2014 (Hejl);
U.S. patent application Ser. No. 14/339,708 for LASER SCANNING CODE SYMBOL READING SYSTEM, filed Jul. 24, 2014 (Xian et al.);
U.S. patent application Ser. No. 14/340,627 for an AXIALLY REINFORCED FLEXIBLE SCAN ELEMENT, filed Jul. 25, 2014 (Rueblinger et al.);
U.S. patent application Ser. No. 14/446,391 for MULTIFUNCTION POINT OF SALE APPARATUS WITH OPTICAL SIGNATURE CAPTURE filed Jul. 30, 2014 (Good et al.);
U.S. patent application Ser. No. 14/452,697 for INTERACTIVE INDICIA READER, filed Aug. 6, 2014 (Todeschini);
U.S. patent application Ser. No. 14/453,019 for DIMENSIONING SYSTEM WITH GUIDED ALIGNMENT, filed Aug. 6, 2014 (Li et al.);
U.S. patent application Ser. No. 14/462,801 for MOBILE COMPUTING DEVICE WITH DATA COGNITION SOFTWARE, filed on Aug. 19, 2014 (Todeschini et al.);
U.S. patent application Ser. No. 14/483,056 for VARIABLE DEPTH OF FIELD BARCODE SCANNER filed Sep. 10, 2014 (McCloskey et al.);
U.S. patent application Ser. No. 14/513,808 for IDENTIFYING INVENTORY ITEMS IN A STORAGE FACILITY filed Oct. 14, 2014 (Singel et al.);
U.S. patent application Ser. No. 14/519,195 for HANDHELD DIMENSIONING SYSTEM WITH FEEDBACK filed Oct. 21, 2014 (Laffargue et al.);
U.S. patent application Ser. No. 14/519,179 for DIMENSIONING SYSTEM WITH MULTIPATH INTERFERENCE MITIGATION filed Oct. 21, 2014 (Thuries et al.);
U.S. patent application Ser. No. 14/519,211 for SYSTEM AND METHOD FOR DIMENSIONING filed Oct. 21, 2014 (Ackley et al.);
U.S. patent application Ser. No. 14/519,233 for HANDHELD DIMENSIONER WITH DATA-QUALITY INDICATION filed Oct. 21, 2014 (Laffargue et al.);
U.S. patent application Ser. No. 14/519,249 for HANDHELD DIMENSIONING SYSTEM WITH MEASUREMENT-CONFORMANCE FEEDBACK filed Oct. 21, 2014 (Ackley et al.);
U.S. patent application Ser. No. 14/527,191 for METHOD AND SYSTEM FOR RECOGNIZING SPEECH USING WILDCARDS IN AN EXPECTED RESPONSE filed Oct. 29, 2014 (Braho et al.);
U.S. patent application Ser. No. 14/529,563 for ADAPTABLE INTERFACE FOR A MOBILE COMPUTING DEVICE filed Oct. 31, 2014 (Schoon et al.);
U.S. patent application Ser. No. 14/529,857 for BARCODE READER WITH SECURITY FEATURES filed Oct. 31, 2014 (Todeschini et al.);
U.S. patent application Ser. No. 14/398,542 for PORTABLE ELECTRONIC DEVICES HAVING A SEPARATE LOCATION TRIGGER UNIT FOR USE IN CONTROLLING AN APPLICATION UNIT filed Nov. 3, 2014 (Bian et al.);
U.S. patent application Ser. No. 14/531,154 for DIRECTING AN INSPECTOR THROUGH AN INSPECTION filed Nov. 3, 2014 (Miller et al.);
U.S. patent application Ser. No. 14/533,319 for BARCODE SCANNING SYSTEM USING WEARABLE DEVICE WITH EMBEDDED CAMERA filed Nov. 5, 2014 (Todeschini);
U.S. patent application Ser. No. 14/535,764 for CONCATENATED EXPECTED RESPONSES FOR SPEECH RECOGNITION filed Nov. 7, 2014 (Braho et al.);
U.S. patent application Ser. No. 14/568,305 for AUTO-CONTRAST VIEWFINDER FOR AN INDICIA READER filed Dec. 12, 2014 (Todeschini);
U.S. patent application Ser. No. 14/573,022 for DYNAMIC DIAGNOSTIC INDICATOR GENERATION filed Dec. 17, 2014 (Goldsmith);
U.S. patent application Ser. No. 14/578,627 for SAFETY SYSTEM AND METHOD filed Dec. 22, 2014 (Ackley et al.);
U.S. patent application Ser. No. 14/580,262 for MEDIA GATE FOR THERMAL TRANSFER PRINTERS filed Dec. 23, 2014 (Bowles);
U.S. patent application Ser. No. 14/590,024 for SHELVING AND PACKAGE LOCATING SYSTEMS FOR DELIVERY VEHICLES filed Jan. 6, 2015 (Payne);
U.S. patent application Ser. No. 14/596,757 for SYSTEM AND METHOD FOR DETECTING BARCODE PRINTING ERRORS filed Jan. 14, 2015 (Ackley);
U.S. patent application Ser. No. 14/416,147 for OPTICAL READING APPARATUS HAVING VARIABLE SETTINGS filed Jan. 21, 2015 (Chen et al.);
U.S. patent application Ser. No. 14/614,706 for DEVICE FOR SUPPORTING AN ELECTRONIC TOOL ON A USER'S HAND filed Feb. 5, 2015 (Oberpriller et al.);
U.S. patent application Ser. No. 14/614,796 for CARGO APPORTIONMENT TECHNIQUES filed Feb. 5, 2015 (Morton et al.);
U.S. patent application Ser. No. 29/516,892 for TABLE COMPUTER filed Feb. 6, 2015 (Bidwell et al.);
U.S. patent application Ser. No. 14/619,093 for METHODS FOR TRAINING A SPEECH RECOGNITION SYSTEM filed Feb. 11, 2015 (Pecorari);
U.S. patent application Ser. No. 14/628,708 for DEVICE, SYSTEM, AND METHOD FOR DETERMINING THE STATUS OF CHECKOUT LANES filed Feb. 23, 2015 (Todeschini);
U.S. patent application Ser. No. 14/630,841 for TERMINAL INCLUDING IMAGING ASSEMBLY filed Feb. 25, 2015 (Gomez et al.);
U.S. patent application Ser. No. 14/635,346 for SYSTEM AND METHOD FOR RELIABLE STORE-AND-FORWARD DATA HANDLING BY ENCODED INFORMATION READING TERMINALS filed Mar. 2, 2015 (Sevier);
U.S. patent application Ser. No. 29/519,017 for SCANNER filed Mar. 2, 2015 (Zhou et al.);
U.S. patent application Ser. No. 14/405,278 for DESIGN PATTERN FOR SECURE STORE filed Mar. 9, 2015 (Zhu et al.);
U.S. patent application Ser. No. 14/660,970 for DECODABLE INDICIA READING TERMINAL WITH COMBINED ILLUMINATION filed Mar. 18, 2015 (Kearney et al.);
U.S. patent application Ser. No. 14/661,013 for REPROGRAMMING SYSTEM AND METHOD FOR DEVICES INCLUDING PROGRAMMING SYMBOL filed Mar. 18, 2015 (Soule et al.);
U.S. patent application Ser. No. 14/662,922 for MULTIFUNCTION POINT OF SALE SYSTEM filed Mar. 19, 2015 (Van Horn et al.);
U.S. patent application Ser. No. 14/663,638 for VEHICLE MOUNT COMPUTER WITH CONFIGURABLE IGNITION SWITCH BEHAVIOR filed Mar. 20, 2015 (Davis et al.);
U.S. patent application Ser. No. 14/664,063 for METHOD AND APPLICATION FOR SCANNING A BARCODE WITH A SMART DEVICE WHILE CONTINUOUSLY RUNNING AND DISPLAYING AN APPLICATION ON THE SMART DEVICE DISPLAY filed Mar. 20, 2015 (Todeschini);
U.S. patent application Ser. No. 14/669,280 for TRANSFORMING COMPONENTS OF A WEB PAGE TO VOICE PROMPTS filed Mar. 26, 2015 (Funyak et al.);
U.S. patent application Ser. No. 14/674,329 for AIMER FOR BARCODE SCANNING filed Mar. 31, 2015 (Bidwell);
U.S. patent application Ser. No. 14/676,109 for INDICIA READER filed Apr. 1, 2015 (Huck);
U.S. patent application Ser. No. 14/676,327 for DEVICE MANAGEMENT PROXY FOR SECURE DEVICES filed Apr. 1, 2015 (Yeakley et al.);
U.S. patent application Ser. No. 14/676,898 for NAVIGATION SYSTEM CONFIGURED TO INTEGRATE MOTION SENSING DEVICE INPUTS filed Apr. 2, 2015 (Showering);
U.S. patent application Ser. No. 14/679,275 for DIMENSIONING SYSTEM CALIBRATION SYSTEMS AND METHODS filed Apr. 6, 2015 (Laffargue et al.);
U.S. patent application Ser. No. 29/523,098 for HANDLE FOR A TABLET COMPUTER filed Apr. 7, 2015 (Bidwell et al.);
U.S. patent application Ser. No. 14/682,615 for SYSTEM AND METHOD FOR POWER MANAGEMENT OF MOBILE DEVICES filed Apr. 9, 2015 (Murawski et al.);
U.S. patent application Ser. No. 14/686,822 for MULTIPLE PLATFORM SUPPORT SYSTEM AND METHOD filed Apr. 15, 2015 (Qu et al.);
U.S. patent application Ser. No. 14/687,289 for SYSTEM FOR COMMUNICATION VIA A PERIPHERAL HUB filed Apr. 15, 2015 (Kohtz et al.);
U.S. patent application Ser. No. 29/524,186 for SCANNER filed Apr. 17, 2015 (Zhou et al.);
U.S. patent application Ser. No. 14/695,364 for MEDICATION MANAGEMENT SYSTEM filed Apr. 24, 2015 (Sewell et al.);
U.S. patent application Ser. No. 14/695,923 for SECURE UNATTENDED NETWORK AUTHENTICATION filed Apr. 24, 2015 (Kubler et al.);
U.S. patent application Ser. No. 29/525,068 for TABLET COMPUTER WITH REMOVABLE SCANNING DEVICE filed Apr. 27, 2015 (Schulte et al.);
U.S. patent application Ser. No. 14/699,436 for SYMBOL READING SYSTEM HAVING PREDICTIVE DIAGNOSTICS filed Apr. 29, 2015 (Nahill et al.);
U.S. patent application Ser. No. 14/702,110 for SYSTEM AND METHOD FOR REGULATING BARCODE DATA INJECTION INTO A RUNNING APPLICATION ON A SMART DEVICE filed May 1, 2015 (Todeschini et al.);
U.S. patent application Ser. No. 14/702,979 for TRACKING BATTERY CONDITIONS filed May 4, 2015 (Young et al.);
U.S. patent application Ser. No. 14/704,050 for INTERMEDIATE LINEAR POSITIONING filed May 5, 2015 (Charpentier et al.);
U.S. patent application Ser. No. 14/705,012 for HANDS-FREE HUMAN MACHINE INTERFACE RESPONSIVE TO A DRIVER OF A VEHICLE filed May 6, 2015 (Fitch et al.);
U.S. patent application Ser. No. 14/705,407 for METHOD AND SYSTEM TO PROTECT SOFTWARE-BASED NETWORK-CONNECTED DEVICES FROM ADVANCED PERSISTENT THREAT filed May 6, 2015 (Hussey et al.);
U.S. patent application Ser. No. 14/707,037 for SYSTEM AND METHOD FOR DISPLAY OF INFORMATION USING A VEHICLE-MOUNT COMPUTER filed May 8, 2015 (Chamberlin);
U.S. patent application Ser. No. 14/707,123 for APPLICATION INDEPENDENT DEX/UCS INTERFACE filed May 8, 2015 (Pape);
U.S. patent application Ser. No. 14/707,492 for METHOD AND APPARATUS FOR READING OPTICAL INDICIA USING A PLURALITY OF DATA SOURCES filed May 8, 2015 (Smith et al.);
U.S. patent application Ser. No. 14/710,666 for PRE-PAID USAGE SYSTEM FOR ENCODED INFORMATION READING TERMINALS filed May 13, 2015 (Smith);
U.S. patent application Ser. No. 29/526,918 for CHARGING BASE filed May 14, 2015 (Fitch et al.);
U.S. patent application Ser. No. 14/715,672 for AUGMENTED REALITY ENABLED HAZARD DISPLAY filed May 19, 2015 (Venkatesha et al.);
U.S. patent application Ser. No. 14/715,916 for EVALUATING IMAGE VALUES filed May 19, 2015 (Ackley);
U.S. patent application Ser. No. 14/722,608 for INTERACTIVE USER INTERFACE FOR CAPTURING A DOCUMENT IN AN IMAGE SIGNAL filed May 27, 2015 (Showering et al.);
U.S. patent application Ser. No. 29/528,165 for IN-COUNTER BARCODE SCANNER filed May 27, 2015 (Oberpriller et al.);
U.S. patent application Ser. No. 14/724,134 for ELECTRONIC DEVICE WITH WIRELESS PATH SELECTION CAPABILITY filed May 28, 2015 (Wang et al.);
U.S. patent application Ser. No. 14/724,849 for METHOD OF PROGRAMMING THE DEFAULT CABLE INTERFACE SOFTWARE IN AN INDICIA READING DEVICE filed May 29, 2015 (Barten);
U.S. patent application Ser. No. 14/724,908 for IMAGING APPARATUS HAVING IMAGING ASSEMBLY filed May 29, 2015 (Barber et al.);
U.S. patent application Ser. No. 14/725,352 for APPARATUS AND METHODS FOR MONITORING ONE OR MORE PORTABLE DATA TERMINALS (Caballero et al.);
U.S. patent application Ser. No. 29/528,590 for ELECTRONIC DEVICE filed May 29, 2015 (Fitch et al.);
U.S. patent application Ser. No. 29/528,890 for MOBILE COMPUTER HOUSING filed Jun. 2, 2015 (Fitch et al.);
U.S. patent application Ser. No. 14/728,397 for DEVICE MANAGEMENT USING VIRTUAL INTERFACES CROSS-REFERENCE TO RELATED APPLICATIONS filed Jun. 2, 2015 (Caballero);
U.S. patent application Ser. No. 14/732,870 for DATA COLLECTION MODULE AND SYSTEM filed Jun. 8, 2015 (Powilleit);
U.S. patent application Ser. No. 29/529,441 for INDICIA READING DEVICE filed Jun. 8, 2015 (Zhou et al.);
U.S. patent application Ser. No. 14/735,717 for INDICIA-READING SYSTEMS HAVING AN INTERFACE WITH A USER'S NERVOUS SYSTEM filed Jun. 10, 2015 (Todeschini);
U.S. patent application Ser. No. 14/738,038 for METHOD OF AND SYSTEM FOR DETECTING OBJECT WEIGHING INTERFERENCES filed Jun. 12, 2015 (Amundsen et al.);
U.S. patent application Ser. No. 14/740,320 for TACTILE SWITCH FOR A MOBILE ELECTRONIC DEVICE filed Jun. 16, 2015 (Bandringa);
U.S. patent application Ser. No. 14/740,373 for CALIBRATING A VOLUME DIMENSIONER filed Jun. 16, 2015 (Ackley et al.);
U.S. patent application Ser. No. 14/742,818 for INDICIA READING SYSTEM EMPLOYING DIGITAL GAIN CONTROL filed Jun. 18, 2015 (Xian et al.);
U.S. patent application Ser. No. 14/743,257 for WIRELESS MESH POINT PORTABLE DATA TERMINAL filed Jun. 18, 2015 (Wang et al.);
U.S. patent application Ser. No. 29/530,600 for CYCLONE filed Jun. 18, 2015 (Vargo et al);
U.S. patent application Ser. No. 14/744,633 for IMAGING APPARATUS COMPRISING IMAGE SENSOR ARRAY HAVING SHARED GLOBAL SHUTTER CIRCUITRY filed Jun. 19, 2015 (Wang);
U.S. patent application Ser. No. 14/744,836 for CLOUD-BASED SYSTEM FOR READING OF DECODABLE INDICIA filed Jun. 19, 2015 (Todeschini et al.);
U.S. patent application Ser. No. 14/745,006 for SELECTIVE OUTPUT OF DECODED MESSAGE DATA filed Jun. 19, 2015 (Todeschini et al.);
U.S. patent application Ser. No. 14/747,197 for OPTICAL PATTERN PROJECTOR filed Jun. 23, 2015 (Thuries et al.);
U.S. patent application Ser. No. 14/747,490 for DUAL-PROJECTOR THREE-DIMENSIONAL SCANNER filed Jun. 23, 2015 (Jovanovski et al.); and
U.S. patent application Ser. No. 14/748,446 for CORDLESS INDICIA READER WITH A MULTIFUNCTION COIL FOR WIRELESS CHARGING AND EAS DEACTIVATION, filed Jun. 24, 2015 (Xie et al.).

In the specification and/or figures, various embodiments of the present invention have been disclosed. The present invention is not limited to such exemplary embodiments. The use of the term “and/or” includes any and all combinations of one or more of the associated listed items. The figures are schematic representations and so are not necessarily drawn to scale. Unless otherwise noted, specific terms have been used in a generic and descriptive sense and not for purposes of limitation.

1. A method for verifying a tool for a workflow process, the method comprising:
receiving, by a processor, a workflow process comprising at least one workflow stage;
identifying, by the processor, a task that is to be performed by a user, the task being at least a portion of the workflow process;
receiving, by the processor, decoded data from a tool, the decoded data identifying the tool;
verifying, by the processor, the decoded data with a verified tool in a verified tool library; and
identifying, by the processor, the tool as a correct tool if the decoded data matches, at least in part, the verified tool and an incorrect tool if the decoded data does not match the verified tool; and
generating and transmitting, by the processor, an indication to the user that the tool is the correct tool or that the tool is the incorrect tool.

2. The method according to claim 1, further comprising stopping, by the processor, the workflow process if the tool is identified as the incorrect tool.

3. The method according to claim 1, further comprising generating and transmitting, by the processor, a description to the user of the correct tool if the tool is identified as the incorrect tool.

4. The method according to claim 1, further comprising generating a work order on the tool if work is requested on the tool, wherein generating the work order comprises printing the work order.

5. A method, comprising:
identifying, by the processor, a task that is to be performed by a user, the task being at least a portion of a workflow process comprising at least one workflow stage;
receiving, by the processor, decoded data from a tool, the decoded data identifying the tool;
verifying, by the processor, the decoded data with a verified tool in a verified tool library; and
identifying, by the processor, the tool as a correct tool if the decoded data matches, at least in part, the verified tool and an incorrect tool if the decoded data does not match the verified tool.

6. The method according to claim 5, further comprising generating and transmitting, by the processor, an indication to the user that the tool is the correct tool or that the tool is the incorrect tool.

7. The method according to claim 6, wherein generating and transmitting the indication to the user that the tool is the incorrect tool comprises generating and transmitting an alert.

8. The method according to claim 5, further comprising stopping, by the processor, the workflow process if the tool is identified as the incorrect tool.

9. The method according to claim 5, further comprising generating and transmitting, by the processor, a description to the user of the correct tool if the tool is identified as the incorrect tool.

10. The method according to claim 5, further comprising generating a work order on the tool if work is requested on the tool, wherein generating the work order comprises printing the work order.

11. A tool verification system, comprising:
a host computing device comprising:
a memory for storing a tool verification program and a verified tool library; and
a processor communicatively coupled to the memory; and
an identification code reader communicatively coupled to the processor and comprising a sensor for reading a unique identification code and transmitting decoded data to the processor, the unique identification code associated with a tool;
wherein the processor is configured by the tool verification program to:
receive the decoded data when the identification code reader is proximate the unique identification code;
verifying the decoded data with the verified tool library; and
identify the tool as a correct tool to be used in the particular workflow stage if the decoded data matches the verified tool and an incorrect tool if the decoded data does not match the verified tool.

12. The system according to claim 11, wherein the host computing device comprises a server, a headset, a laptop computing device, a tablet computing device, a handheld computing device, or a mobile telecommunications device.

13. The system according to claim 12, wherein the identification code reader is embedded in the host computing device.

14. The system according to claim 12, wherein the identification code reader is included in a mobile device communicatively coupled by a wireless data link to the host computing device.

15. The system according to claim 14, wherein the mobile device comprises a wearable mobile device.

16. The system according to claim 14, wherein the wireless data link comprises a Bluetooth® communication protocol, a WI-FI® communication protocol, or a Zigbee® communication protocol.

17. The system according to claim 11, wherein the processor is further configured to generate and transmit an alert to the user that the tool is not the correct tool.

18. The system according to claim 11, wherein the processor is further configured to generate and transmit an indication whether the tool is identified as the correct tool or an incorrect tool.

19. The system according to claim 11, wherein the processor is further configured to stop the workflow process if the tool is identified as the incorrect tool.

20. The system according to claim 11, wherein the processor is further configured to generate and transmit a description to the user of the correct tool if the tool is identified as the incorrect tool.
